(19) United States
(12) Patent Application Publication
(10) Pub. No.: US 2005/0029225 A1
(43) Pub. Date: Feb. 10, 2005

(54) Electrochemical fabrication methods with enhanced post deposition processing

(75) Inventor: Gang Zhang, Monterey Park, CA (US)

Correspondence Address: MICROFABRICA INC.;DENNIS R. SMALLEY, 1103 W. ISABEL ST., BURBANK, CA, 91506, US

(73) Assignee: University of Southern California

(21) Appl. No.: 10/840,998

(22) Filed: May 7, 2004

Related U.S. Application Data
(63) Continuation-in-part of application No. 10/434,294, filed on May 7, 2003.
(60) Provisional application No. 60/379,134, filed on May 7, 2002.

(51) Int. Cl. B44C 1/22

(52) U.S. Cl. 216/40

(57) ABSTRACT

An electrochemical fabrication process for producing three-dimensional structures from a plurality of adhered layers is provided where each layer comprises at least one structural material (e.g. nickel or nickel alloy) and at least one sacrificial material (e.g. copper) that will be etched away from the structural material after the formation of all layers have been completed. An etchant containing chlorite (e.g. Enthone C-38) is combined with a corrosion inhibitor (e.g. sodium nitrate) to prevent pitting of the structural material during removal of the sacrificial material. A simple process for drying the etched structure without the drying process causing surfaces to stick together includes immersion of the structure in water after etching and then immersion in alcohol and then placing the structure in an oven for drying.

RELATED APPLICATIONS

This application is a continuation-in-part of U.S. patent application Ser. No. 10/434,294, which was filed on May 7, 2003, which in turn claims benefit of U.S. Provisional Patent Application No. 60/379,134 which was filed on May 7, 2002. Both of these priority applications are incorporated herein by reference as if set forth in full.

### FIELD OF THE INVENTION

This invention relates to the field of electrochemical deposition and more particularly to the field of electrochemical deposition either adhered masks and/or using conformable contact masks, that are formed separate from a substrate, to control deposition, such as for example in Electrochemical Fabrication (e.g. EFAB™) where such masks are used to control the selective electrochemical deposition of one or more materials according to desired cross-sectional configurations so as to build up three-dimensional structures from a plurality of at least partially adhered layers of deposited material.

### BAKCGROUND

A technique for forming three-dimensional structures (e.g. parts, components, devices, and the like) from a plurality of adhered layers was invented by Adam L. Cohen and is known as Electrochemical Fabrication. It is being commercially pursued by MEMGen® Corporation of Burbank, Calif. under the name EFAB™. This technique was described in U.S. Pat. No. 6,027,630, issued on Feb. 22, 2000. This electrochemical deposition technique allows the selective deposition of a material using a unique masking technique that involves the use of a mask that includes patterned conformable material on a support structure that is independent of the substrate onto which plating will occur. When desiring to perform an electrodeposition using the mask, the conformable portion of the mask is brought into contact with a substrate while in the presence of a plating solution such that the contact of the conformable portion of the mask to the substrate inhibits deposition at selected locations. For convenience, these masks might be generically called conformable contact masks; the masking technique may be generically called a conformable contact mask plating process. More specifically, in the terminology of MEMGen® Corporation of Burbank, Calif. such masks have come to be known as INSTANT MASKS™ and the process known as INSTANT MASKING™ or INSTANT MASK™ plating. Selective depositions using conformable contact mask plating may be used to form single layers of material or may be used to form multi-layer structures. The teachings of the '630 patent are hereby incorporated herein by reference as if set forth in full herein. Since the filing of the patent application that led to the above noted patent, various papers about conformable contact mask plating (i.e. INSTANT MASKING) and electrochemical fabrication have been published:
1. A. Cohen, G. Zhang, F. Tseng, F. Mansfeld, U. Frodis and P. Will, “EFAB: Batch production of functional, fully-dense metal parts with micro-scale features”, Proc. 9th Solid Freeform Fabrication, The University of Texas at Austin, p161, August 1998.
2. A. Cohen, G. Zhang, F. Tseng, F. Mansfeld, U. Frodis and P. Will, “EFAB: Rapid, Low-Cost Desktop Micromachining of High Aspect Ratio True 3-D MEMS”, Proc. 12th IEEE Micro Electro Mechanical Systems Workshop, IEEE, p244, January 1999.
3. A. Cohen, “3-D Micromachining by Electrochemical Fabrication”, Micromachine Devices, March 1999.
4. G. Zhang, A. Cohen, U. Frodis, F. Tseng, F. Mansfeld, and P. Will, “EFAB: Rapid Desktop Manufacturing of True 3-D Microstructures”, Proc. 2nd International Conference on Integrated MicroNanotechnology for Space Applications, The Aerospace Co., April 1999.
5. F. Tseng, U. Frodis, G. Zhang, A. Cohen, F. Mansfeld, and P. Will, “EFAB: High Aspect Ratio, Arbitrary 3-D Metal Microstructures using a Low-Cost Automated Batch Process”, 3rd International Workshop on High Aspect Ratio MicroStructure Technology (HARMST'99), June 1999.
6. A. Cohen, U. Frodis, F. Tseng, G. Zhang, F. Mansfeld, and P. Will, “EFAB: Low-Cost, Automated Electrochemical Batch Fabrication of Arbitrary 3-D Microstructures”, Micromachining and Microfabrication Process Technology, SPIE 1999 Symposium on Micromachining and Microfabrication, September 1999.
7. F. Tseng, G. Zhang, U. Frodis, A. Cohen, F. Mansfeld, and P. Will, “EFAB: High Aspect Ratio, Arbitrary 3-D Metal Microstructures using a Low-Cost Automated Batch Process”, MEMS Symposium, ASME 1999 International Mechanical Engineering Congress and Exposition, November, 1999.
8. A. Cohen, “Electrochemical Fabrication (EFABTM)”, Chapter 19 of The MEMS Handbook, edited by Mohamed Gad-El-Hak, CRC Press, 2002.
9. “Microfabrication—Rapid Prototyping's Killer Application”, pages 1-5 of the Rapid Prototyping Report, CAD/CAM Publishing, Inc., June 1999.

The disclosures of these nine publications are hereby incorporated herein by reference as if set forth in full herein.

The electrochemical deposition process may be carried out in a number of different ways as set forth in the above patent and publications. In one form, this process involves the execution of three separate operations during the formation of each layer of the structure that is to be formed:
1. Selectively depositing at least one material by electrodeposition upon one or more desired regions of a substrate.
2. Then, blanket depositing at least one additional material by electrodeposition so that the additional deposit covers both the regions that were previously selectively deposited onto, and the regions of the substrate that did not receive any previously applied selective depositions.
3. Finally, planarizing the materials deposited during the first and second operations to produce a smoothed surface of a first layer of desired thickness having at least one region containing the at least one material and at least one region containing at least the one additional material.

After formation of the first layer, one or more additional layers may be formed adjacent to the immediately preceding layer and adhered to the smoothed surface of that preceding layer. These additional layers are formed by repeating the first through third operations one or more times wherein the formation of each subsequent layer treats the previously formed layers and the initial substrate as a new and thickening substrate.

Once the formation of all layers has been completed, at least a portion of at least one of the materials deposited is generally removed by an etching process to expose or release the three-dimensional structure that was intended to be formed.

The preferred method of performing the selective electrodeposition involved in the first operation is by conformable contact mask plating. In this type of plating, one or more conformable contact (CC) masks are first formed. The CC masks include a support structure onto which a patterned conformable dielectric material is adhered or formed. The conformable material for each mask is shaped in accordance with a particular cross-section of material to be plated. At least one CC mask is needed for each unique cross-sectional pattern that is to be plated.

The support for a CC mask is typically a plate-like structure formed of a metal that is to be selectively electroplated and from which material to be plated will be dissolved. In this typical approach, the support will act as an anode in an electroplating process. In an alternative approach, the support may instead be a porous or otherwise perforated material through which deposition material will pass during an electroplating operation on its way from a distal anode to a deposition surface. In either approach, it is possible for CC masks to share a common support, i.e. the patterns of conformable dielectric material for plating multiple layers of material may be located in different areas of a single support structure. When a single support structure contains multiple plating patterns, the entire structure is referred to as the CC mask while the individual plating masks may be referred to as “submasks”. In the present application such a distinction will be made only when relevant to a specific point being made.

In preparation for performing the selective deposition of the first operation, the conformable portion of the CC mask is placed in registration with and pressed against a selected portion of the substrate (or onto a previously formed layer or onto a previously deposited portion of a layer) on which deposition is to occur. The pressing together of the CC mask and substrate occur in such a way that all openings, in the conformable portions of the CC mask contain plating solution. The conformable material of the CC mask that contacts the substrate acts as a barrier to electrodeposition while the openings in the CC mask that are filled with electroplating solution act as pathways for transferring material from an anode (e.g. the CC mask support) to the non-contacted portions of the substrate (which act as a cathode during the plating operation) when an appropriate potential and/or current are supplied.

An example of a CC mask and CC mask plating are shown in FIGS. 1(a)-1(c). FIG. 1(a) shows a side view of a CC mask 8 consisting of a conformable or deformable (e.g. elastomeric) insulator 10 patterned on an anode 12. The anode has two functions. FIG. 1(a) also depicts a substrate 6 separated from mask 8. One is as a supporting material for the patterned insulator 10 to maintain its integrity and alignment since the pattern may be topologically complex (e.g., involving isolated “islands” of insulator material). The other function is as an anode for the electroplating operation. CC mask plating selectively deposits material 22 onto a substrate 6 by simply pressing the insulator against the substrate then electrodepositing material through apertures 26a and 26b in the insulator as shown in FIG. 1(b). After deposition, the CC mask is separated, preferably non-destructively, from the substrate 6 as shown in FIG. 1(c). The CC mask plating process is distinct from a “through-mask” plating process in that in a through-mask plating process the separation of the masking material from the substrate would occur destructively. As with through-mask plating, CC mask plating deposits material selectively and simultaneously over the entire layer. The plated region may consist of one or more isolated plating regions where these isolated plating regions may belong to a single structure that is being formed or may belong to multiple structures that are being formed simultaneously. In CC mask plating as individual masks are not intentionally destroyed in the removal process, they may be usable in multiple plating operations.

Another example of a CC mask and CC mask plating is shown in FIGS. 1(d)-1(f). FIG. 1(d) shows an anode 12′ separated from a mask 8′ that comprises a patterned conformable material 10′ and a support structure 20. FIG. 1(d) also depicts substrate 6 separated from the mask 8′. FIG. 1(e) illustrates the mask 8′ being brought into contact with the substrate 6. FIG. 1(f) illustrates the deposit 22′ that results from conducting a current from the anode 12′ to the substrate 6. FIG. 1(g) illustrates the deposit 22′ on substrate 6 after separation from mask 8′. In this example, an appropriate electrolyte is located between the substrate 6 and the anode 12′ and a current of ions coming from one or both of the solution and the anode are conducted through the opening in the mask to the substrate where material is deposited. This type of mask may be referred to as an anodeless INSTANT MASK™ (AIM) or as an anodeless conformable contact (ACC) mask.

Unlike through-mask plating, CC mask plating allows CC masks to be formed completely separate from the fabrication of the substrate on which plating is to occur (e.g. separate from a three-dimensional (3D) structure that is being formed). CC masks may be formed in a variety of ways, for example, a photolithographic process may be used. All masks can be generated simultaneously, prior to structure fabrication rather than during it. This separation makes possible a simple, low-cost, automated, self-contained, and internally-clean “desktop factory” that can be installed almost anywhere to fabricate 3D structures, leaving any required clean room processes, such as photolithography to be performed by service bureaus or the like.

An example of the electrochemical fabrication process discussed above is illustrated in FIGS. 2(a)-2(f). These figures show that the process involves deposition of a first material 2 which is a sacrificial material and a second material 4 which is a structural material. The CC mask 8, in this example, includes a patterned conformable material (e.g. an elastomeric dielectric material) 10 and a support 12 which is made from deposition material 2. The conformal portion of the CC mask is pressed against substrate 6 with a plating solution 14 located within the openings 16 in the conformable material 10. An electric current, from power supply 18, is then passed through the plating solution 14 via (a) support 12 which doubles as an anode and (b) substrate 6 which doubles as a cathode. FIG. 2(a), illustrates that the passing of current causes material 2 within the plating solution and material 2 from the anode 12 to be selectively transferred to and plated on the cathode 6. After electroplating the first deposition material 2 onto the substrate 6 using CC mask 8, the CC mask 8 is removed as shown in FIG. 2(b). FIG. 2(c) depicts the second deposition material 4 as having been blanket-deposited (i.e. non-selectively deposited) over the previously deposited first deposition material 2 as well as over the other portions of the substrate 6. The blanket deposition occurs by electroplating from an anode (not shown), composed of the second material, through an appropriate plating solution (not shown), and to the cathode/substrate 6. The entire two-material layer is then planarized to achieve precise thickness and flatness as shown in FIG. 2(d). After repetition of this process for all layers, the multi-layer structure 20 formed of the second material 4 (i.e. structural material) is embedded in first material 2 (i.e. sacrificial material) as shown in FIG. 2(e). The embedded structure is etched to yield the desired device, i.e. structure 20, as shown in FIG. 2(f).

Various components of an exemplary manual electrochemical fabrication system 32 are shown in FIGS. 3(a)-3(c). The system 32 consists of several subsystems 34, 36, 38, and 40. The substrate holding subsystem 34 is depicted in the upper portions of each of FIGS. 3(a) to 3(c) and includes several components: (1) a carrier 48, (2) a metal substrate 6 onto which the layers are deposited, and (3) a linear slide 42 capable of moving the substrate 6 up and down relative to the carrier 48 in response to drive force from actuator 44. Subsystem 34 also includes an indicator 46 for measuring differences in vertical position of the substrate which may be used in setting or determining layer thicknesses and/or deposition thicknesses. The subsystem 34 further includes feet 68 for carrier 48 which can be precisely mounted on subsystem 36.

The CC mask subsystem 36 shown in the lower portion of FIG. 3(a) includes several components: (1) a CC mask 8 that is actually made up of a number of CC masks (i.e. submasks) that share a common support/anode 12, (2) precision X-stage 54, (3) precision Y-stage 56, (4) frame 72 on which the feet 68 of subsystem 34 can mount, and (5) a tank 58 for containing the electrolyte 16. Subsystems 34 and 36 also include appropriate electrical connections (not shown) for connecting to an appropriate power source for driving the CC masking process.

The blanket deposition subsystem 38 is shown in the lower portion of FIG. 3(b) and includes several components: (1) an anode 62, (2) an electrolyte tank 64 for holding plating solution 66, and (3) frame 74 on which the feet 68 of subsystem 34 may sit. Subsystem 38 also includes appropriate electrical connections (not shown) for connecting the anode to an appropriate power supply for driving the blanket deposition process.

The planarization subsystem 40 is shown in the lower portion of FIG. 3(c) and includes a lapping plate 52 and associated motion and control systems (not shown) for planarizing the depositions.

Another method for forming microstructures from electroplated metals (i.e. using electrochemical fabrication techniques) is taught in U.S. Pat. No. 5,190,637 to Henry Guckel, entitled “Formation of Microstructures by Multiple Level Deep X-ray Lithography with Sacrificial Metal layers. This patent teaches the formation of metal structure utilizing mask exposures. A first layer of a primary metal is electroplated onto an exposed plating base to fill a void in a photoresist, the photoresist is then removed and a secondary metal is electroplated over the first layer and over the plating base. The exposed surface of the secondary metal is then machined down to a height which exposes the first metal to produce a flat uniform surface extending across the both the primary and secondary metals. Formation of a second layer may then begin by applying a photoresist layer over the first layer and then repeating the process used to produce the first layer.

The process is then repeated until the entire structure is formed and the secondary metal is removed by etching. The photoresist is formed over the plating base or previous layer by casting and the voids in the photoresist are formed by exposure of the photoresist through a patterned mask via X-rays or UV radiation.

The '630 patent as well as the other conformable contact mask plating (i.e. Instant Mask Plating) and electrochemical fabrication (i.e. EFAB) publications noted above describe copper as a sacrificial material and nickel as a structural material. The copper is the preferred material for selective deposition while the nickel is the preferred material for blanket deposition. In most applications after formation of the nickel structure it is desirable to reveal it by separating it from the copper sacrificial material. The '630 patent proposes that this removal be performed by an etching operation and that useful etching compositions for selectively stripping copper from nickel structures include (1) solutions of ammonium hydroxide and copper sulfate or (2) solutions of ammonium hydroxide and sodium chlorite. This prior art patent indicates that a preferred etchant is Enstrip C38 commercially available from Enthone OMI. The patent goes further and indicates that etching can also be performed in the presence of (1) vibrations, e.g., ultrasound applied to the etchant or the substrate that was plated, and (2) pressurized jets of etchant contacting the metal to be etched.

In September of 1998, Adam Cohen placed an enquiry onto the “mems-talk” mailing list at http://mail.mems-exchange.org. In this enquiry Mr. Cohen indicated that he was seeking suggestions concerning a Cu etchant that didn't cause pitting or other damage to Ni. He further indicated that Enthone's Enstrip C38 caused pitting at least sometimes. In October of 1998, Mr. Cohen received three responses to this enquiry: (1) recommendation to use a copper etching process that showed no pitting problems with nickel—the etchant was HNO3:H3PO4:CH3COOH at 0.5:50.0:49.5 (volume) and was used at room temperature; (2) recommendation to use a caustic etchant and in particular Cu(NH3)4++ mixed with ammonia; and (3) recommendation to try 50% NH4OH mixed with 50% H2O2 in a 1:1 ratio.

A need remains in the field of conformable contact mask plating and electrochemical fabrication (e.g. with contact masks or with adhered masks) for improved post deposition processing and in particular for processes that separate copper from nickel or nickel alloys while minimizing the pitting of nickel or nickel alloy structure), and more particularly to provide an improved process of separating copper or another sacrificial material from nickel or nickel alloys when the nickel or nickel alloy structure has a complex geometry with sacrificial material needing to be removed from small but extended or even intricate passages within the nickel structure.

### SUMMARY OF THE INVENTION

It is an object of certain aspects of the invention to provide improved post deposition processing for structures produced by conformable contact mask plating or electrochemical fabrication.

It is an object of certain aspects of the invention to provide improved post deposition processing for structures produced using adhered masks.

It is an object of certain aspects of the invention to provide an improved process for separating a sacrificial material (e.g. copper) from nickel or from nickel alloys.

It is an object of certain aspects of the invention to provide an improved process for separating a copper from a structural material (e.g a nickel or nickel alloy).

It is an object of certain aspects of the invention to provide a generalized sacrificial material (e.g. copper or copper alloy) removal process that can be used to remove the sacrificial material from a complex structure that includes nickel or nickel alloy without damaging the nickel or nickel alloy.

Other objects and advantages of various aspects of the invention will be apparent to those of skill in the art upon review of the teachings herein. The various aspects of the invention, set forth explicitly herein or otherwise ascertained from the teachings herein, may address any one of the above objects alone or in combination, or alternatively may not address any of the objects set forth above but instead address some other object that may be ascertainable from the teachings herein. It is not intended that all of these objects be addressed by any single aspect of the invention even though that may be the case with regard to some aspects.

A first aspect of the invention provides an electrochemical fabrication process for producing a three-dimensional structure from a plurality of adhered layers, the process that includes: (A) selectively depositing a first material onto a substrate to form a portion of a layer and depositing at least a second material to form another portion of the layer, wherein the substrate may comprise previously deposited material, and wherein one of the first material or the second material is a structural material and the other is a sacrificial material; (B) forming a plurality of layers such that each successive layer is formed adjacent to and adhered to a previously deposited layer, wherein said forming comprises repeating operation (A) a plurality times, wherein during formation of at least one layer an adhered mask is used in selectively depositing the first material; and (C) after formation of a plurality of layers, separating at least a portion of the sacrificial material from the structural material using an etching solution that comprises ammonium hydroxide, a chlorite salt, and a nitrate salt.

A second aspect of the invention provides a process for an electrochemical fabrication process for producing a three-dimensional structure from a plurality of adhered layers, the process including: (A) selectively patterning a first material on a substrate to form a portion of a layer and depositing at least a second material to form another portion of the layer, wherein the substrate may comprise previously deposited material, and wherein one of the first material or the second material is a structural material and the other is a sacrificial material; (B) forming a plurality of layers such that each successive layer is formed adjacent to and adhered to a previously deposited layer, wherein said forming comprises repeating operation (A) a plurality times, wherein during formation of at least one layer an adhered mask is used in selectively patterning the first material; and (C) after formation of a plurality of layers, separating at least a portion of the sacrificial material from the structural material using an etching solution that comprises ammonium hydroxide, a chlorite salt, and a nitrate salt.

A third aspect of the invention provides an electrochemical fabrication process for producing a three-dimensional structure from a plurality of adhered layers, the process comprising: (A) selectively depositing a first material onto a substrate to form a portion of a layer and depositing at least a second material to form another portion of the layer, wherein the substrate may comprise previously deposited material, and wherein one of the first material or the second material is a structural material and the other is a sacrificial material; (B) forming a plurality of layers such that each successive layer is formed adjacent to and adhered to a previously deposited layer, wherein said forming comprises repeating operation (A) a plurality times, wherein during formation of at least one layer an adhered mask is used in selectively depositing the first material; and (C) after formation of a plurality of layers, separating at least a portion of the sacrificial material from the structural material using an etching solution that comprises a corrosion inhibitor.

Further aspects of the invention will be understood by those of skill in the art upon reviewing the teachings herein. Other aspects of the invention may involve combinations of the above noted aspects of the invention and/or addition of various features of one or more embodiments. Other aspects of the invention may involve apparatus that can be used in implementing one or more of the above method aspects of the invention. These other aspects of the invention may provide various combinations of the aspects presented above as well as provide other configurations, structures, functional relationships, and processes that have not been specifically set forth above.

### BRIEF DESCRIPTION OF THE DRAWINGS

FIGS. 1(a)-1(c) schematically depict side views of various stages of a CC mask plating process, while FIGS. 1(d)-(g) schematically depict a side views of various stages of a CC mask plating process using a different type of CC mask.

FIGS. 2(a)-2(f) schematically depict side views of various stages of an electrochemical fabrication process as applied to the formation of a particular structure where a sacrificial material is selectively deposited while a structural material is blanket deposited.

FIGS. 3(a)-3(c) schematically depict side views of various example subassemblies that may be used in manually implementing the electrochemical fabrication method depicted in FIGS. 2(a)-2(f).

FIGS. 4(a)-4(i) schematically depict the formation of a first layer of a structure using adhered mask plating where the blanket deposition of a second material overlays both the openings between deposition locations of a first material and the first material itself.

FIG. 5 depicts a table of copper etchants and various properties associated with them.

FIG. 6 depicts a plot of etching rate versus C-38 copper stripper concentration.

FIG. 7 depicts a scanning electron microscope image of a nickel structure damaged by an etchant process that included excessive vibration.

FIG. 8 depicts a nickel structure that was pitted by etching with C-38.

FIG. 9 depicts a plot of etched length of a copper wire versus etching time.

### DETAILED DESCRIPTION

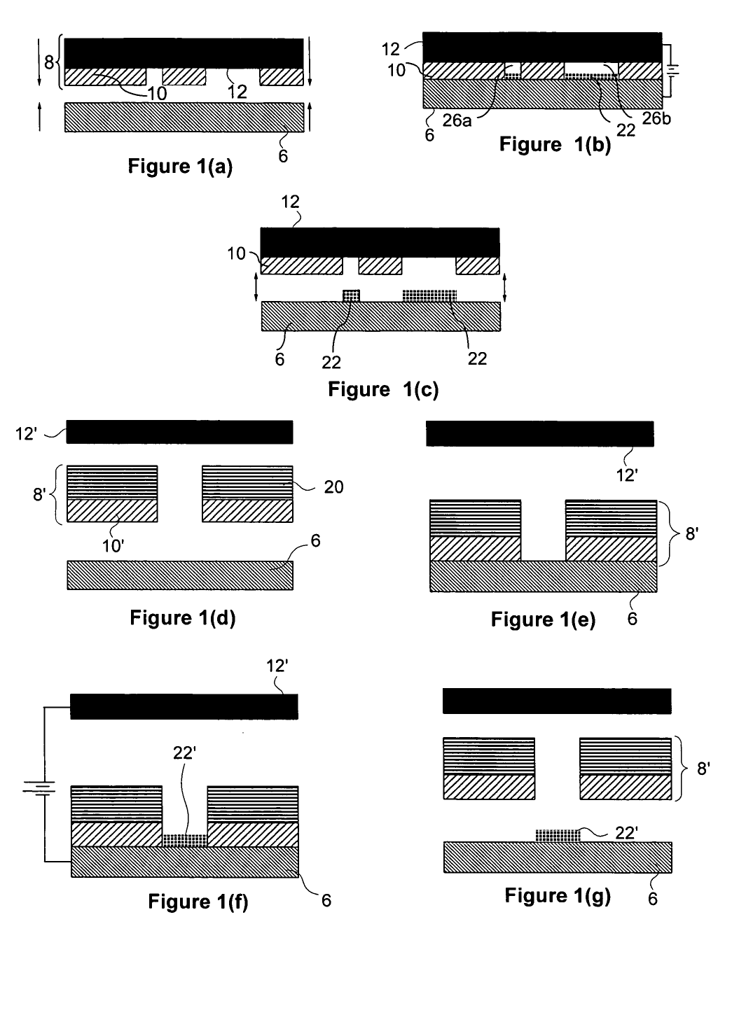

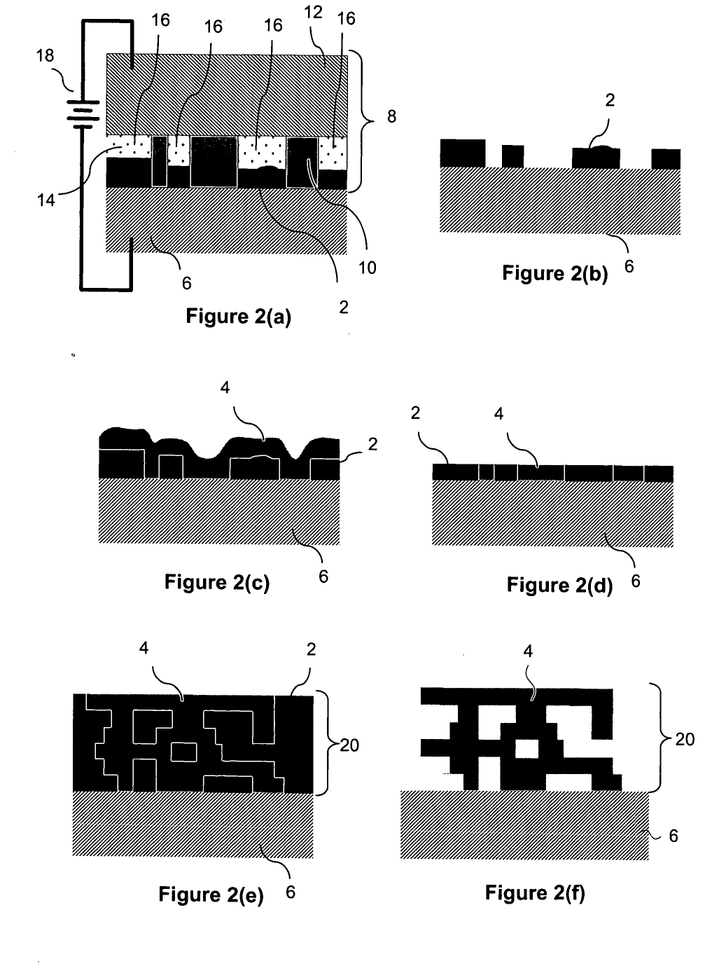

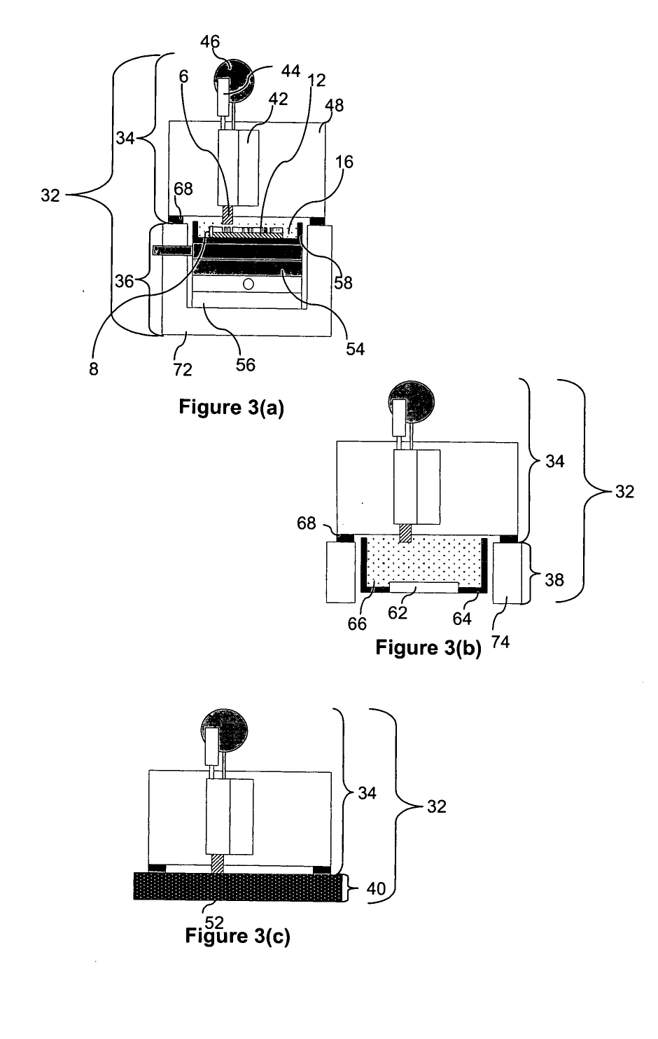

FIGS. 1(a)-1(g), 2(a)-2(f), and 3(a)-3(c) illustrate various features of one form of electrochemical fabrication that are known. Other electrochemical fabrication techniques are set forth in the '630 patent referenced above, in the various previously incorporated publications, in various other patents and patent applications incorporated herein by reference, still others may be derived from combinations of various approaches described in these publications, patents, and applications, or are otherwise known or ascertainable by those of skill in the art from the teachings set forth herein. All of these techniques may be combined with those of the various embodiments of various aspects of the invention to yield enhanced embodiments. Still other embodiments be may derived from combinations of the various embodiments explicitly set forth herein.

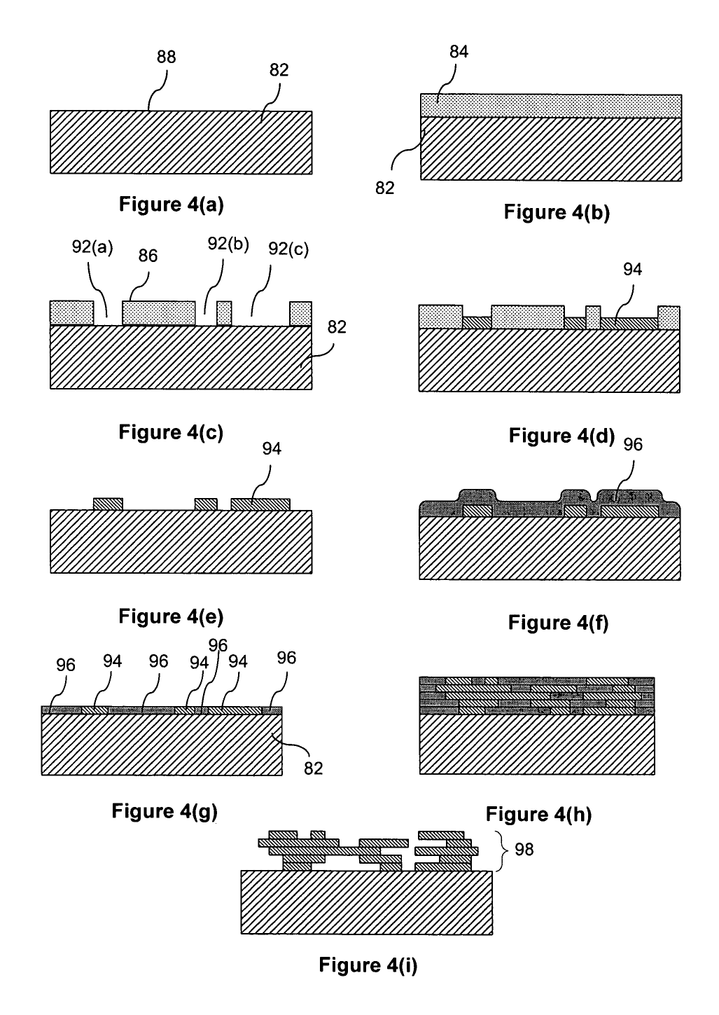

FIGS. 4(a)-4(i) illustrate various stages in the formation of a single layer of a multi-layer fabrication process where a second metal is deposited on a first metal as well as in openings in the first metal where its deposition forms part of the layer. In FIG. 4(a), a side view of a substrate 82 is shown, onto which patternable photoresist 84 is cast as shown in FIG. 4(b). In FIG. 4(c), a pattern of resist is shown that results from the curing, exposing, and developing of the resist. The patterning of the photoresist 84 results in openings or apertures 92(a)-92(c) extending from a surface 86 of the photoresist through the thickness of the photoresist to surface 88 of the substrate 82. In FIG. 4(d), a metal 94 (e.g. nickel) is shown as having been electroplated into the openings 92(a)-92(c). In FIG. 4(e), the photoresist has been removed (i.e. chemically stripped) from the substrate to expose regions of the substrate 82 which are not covered with the first metal 94. In FIG. 4(f), a second metal 96 (e.g., silver) is shown as having been blanket electroplated over the entire exposed portions of the substrate 82 (which is conductive) and over the first metal 94 (which is also conductive). FIG. 4(g) depicts the completed first layer of the structure which has resulted from the planarization of the first and second metals down to a height that exposes the first metal and sets a thickness for the first layer. In FIG. 4(h) the result of repeating the process steps shown in FIGS. 4(b)-4(g) several times to form a multi-layer structure are shown where each layer consists of two materials. For most applications, one of these materials is removed as shown in FIG. 4(i) to yield a desired 3-D structure 98 (e.g. component or device).

In some preferred conformable contact mask plating and electrochemical fabrication embodiments, deposition and etching of a sacrificial material, such as copper, are essential steps. The sacrificial material serves as a mechanical support of the structural material during structure formation. Additionally, since the sacrificial material, like the structural material, is conductive, additional material can be deposited over the entire layer without constraint. Thus the use of a sacrificial material eliminates virtually all geometrical restrictions, allowing the structural material on a layer to overhang and even be disconnected from that of the previous layer. Furthermore, the use of a sacrificial material may allow a broader range of structural materials to be used in that the sacrificial material can be deposited in a selective process (e.g. by a conformable contact mask process) while the structural material may be deposited in some other manner (e.g. blanket deposition) where fewer deposition limitations may exist.

The basic rules governing etching are as follows:
1. Selectivity: Etchants should only remove sacrificial materials. No or little effect on main materials should occur.
2. Completion: A sacrificial material needs to be removed completely.
3. Speed: The less the etching time the higher the throughput.
4. Integration: An etching process should not damage delicate structures.

Wet etching is a fast, cheap process and can also remove materials from blind geometries. Usually, to remove a metal, it must be of an oxidized form so as to transition from the metallic to an ionic state. Therefore, the active ingredient in a metal etchant needs to be an oxidizing agent. Alternatively, electrochemical anodic etching provides the required oxidizing action by passing a current of cations from a work piece. An acid or alkaline complexing agent may be included to increase the etching rate. Other additives may also be included. Common oxidizing agents used for stripping copper include chlorite, ferric chloride, cupric chloride, persulfate, organic nitro compounds, and peroxide.

In electrochemical fabrication, a fast reliable copper etching process without negative effect on structural material (e.g. nickel) and associated structures desired necessary to achieve the final structures (e.g. microstructures).

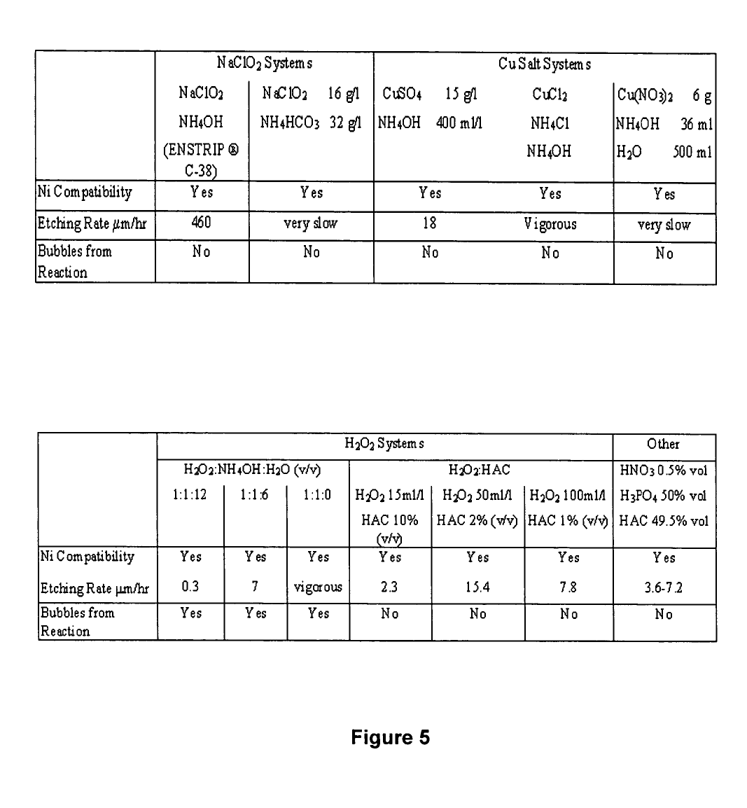

Some common copper etchants were evaluated for use in electrochemical fabrication and are listed in FIG. 5. In the evaluation (1) etching rates for the etchants were determined from either tests or from references, (2) Ni compatibility was determined, and (3) the etching processes for each etchant were examined. Copper foil samples were used for measuring etching rates and had dimensions of 2 cm×4 cm×60 μm and a purity of 99.5%. To hold the samples in the etchant solutions, a hole was drilled with a diameter of 0.48 cm in each sample. Etching time was variable depending on actual reaction rate of each etchant at room temperature (˜20° C.). The etching rate in each etchant was determined from the difference in measured weight of the copper foil before and after the test.

Although these etchants were reported to be nickel compatible, etchants with slow etching rate and bubble formation during the etching process were not considered further. A slow etching rate means more process time while vigorous bubble formation could induce stress in free standing structures such as beams and cantilevers, could break delicate microstructures, or could inhibit etchant access into small passages. Though most of the etchants were successful in removing thin sacrificial copper films, their slow etching rates and/or bubble formation make them impractical for removing relatively large amounts of copper in electrochemical fabrication or similar cases. Of the etchants evaluated the ENSTRIP® C-38 stripper had an etching rate of 460 μm/hr and appeared to be the most promising.

ENSTRIP® C-38 stripper (Enthone-OMI Inc. of New Haven, Conn.) is a two-component, ammoniacal immersion stripper designed to quickly remove copper from steel and stainless steel substrates. The recommended C-38 stripper is formed from two primary components, Enstrip C-38A at 75% by volume and Enstrip C-38B at 25% by volume. It is recommended that the Enstrip C-38 solution should only be operated within the pH range of 9.3 to 10.5 and within a temperature range from room temperature to a maximum of 38° C. If the solution pH becomes too low, it is recommended that 27% ammonium hydroxide be added in small increments until the pH is brought into the right range. It is believed that the two main components of the C-38 solution are sodium chlorite, NaClO2, and ammonium hydroxide, NH4OH. The C-38 solution can dissolve up to 8 ounces of copper per gallon of solution. The C-38 basic reaction mechanism is believed to be:

On the etching surface:
ClO₂⁻+H₂O+2e→ClO⁻+2OH⁻
2Cu−2e→2Cu⁺
Cu⁺+2NH₃→[Cu(NH₃)₂]⁺

In the bulk solution:
ClO₂⁻+H₂O+2e→ClO⁻+2OH⁻
2[Cu(NH₃)₂]⁺+4NH₃−2e→2[Cu(NH₃)₄]²⁺

C-38 does not attack nickel significantly. Experiments showed that the nickel corrosion rate in C-38 is only about 72 μm/yr. For a short etching time, the actual amount of etched nickel is negligible. To extend the range of electrochemical fabrication structural materials beyond nickel, the etching rates of other metals and alloys were tested in C-38. Samples with a known area and weight were immersed into C-38 at room temperature for a known time. The etching rate was calculated from the corresponding weight loss. The test results are listed in the following table.

| Testing | | Etching Rate in C38 at 20° C. |
|---|---|---|
| Material | Form of Material | (μm/hr) |
| Cu | Cu foil, 99.5% | ˜460 |
| Ni | Ni Deposit from Ni sulfamate | ˜0 |
| | bath | |
| Fe | Mild steel, >99% | 0.02 |
| Au | Gold Mirror | ˜0 |
| Ag | Silver wire, 99.99% | 0.41 |
| Pt | Platinum wire | ˜0 |
| Sn | Tin round, 99.85% | 0.02 |
| Pb | Lead wire, 99.92% | 0.08 |
| Zn | Zinc wire, 99.9% | Dissolved quickly |
| Sn—Ag | Solder wire, 96%-4% | 0.02 |
| Pd—Sn | Solder wire, 60%-40% | 0.10 |
| Fe—Ni | | ˜0 |

Compatibility of Metals and Alloys in C-38

Zinc is not suitable for use as an unprotected structural material but may be useful as a sacrificial material since it is quickly dissolved in C-38. All other metals and alloys that were tested were determined to be useful as structural materials when C-38 is the etchant.

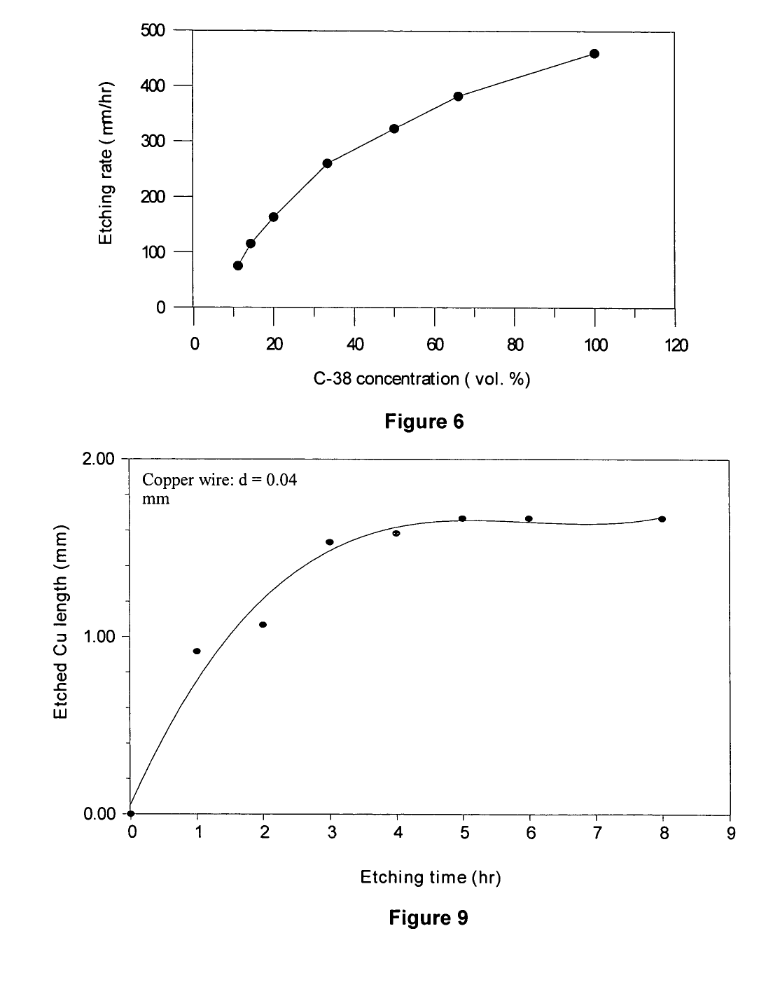

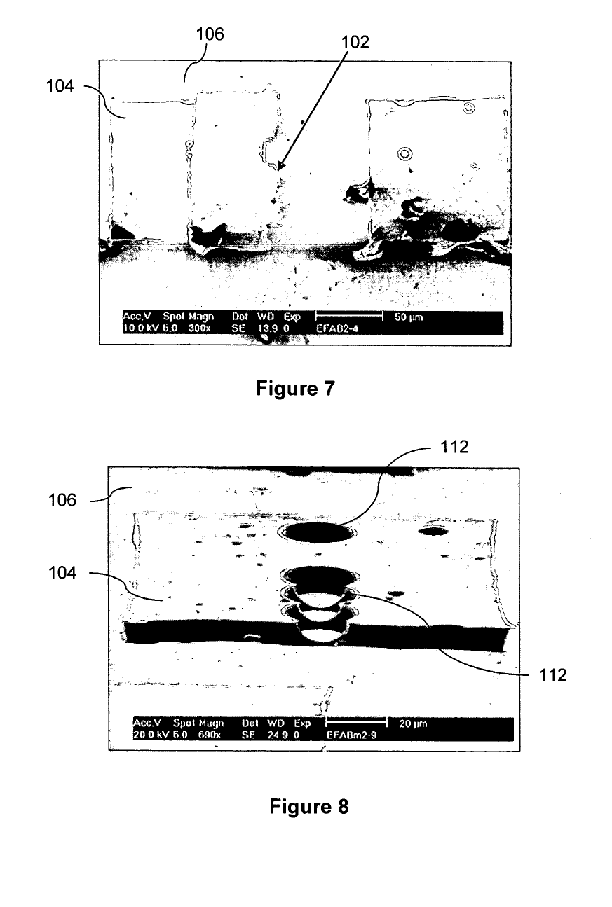

The etching rate of copper in C-38 can be adjusted downward by diluting the full strength C-38. A plot of etching rates versus C-38 concentration is shown in FIG. 6. For real microstructure release, the etching rate will be lower and will depend on actual geometric complexity since an etching rate is determined by rates of (1) fresh etchant delivery to etching surface and (2) reaction products delivery to the bulk solution. For example, one experiment indicated that the etching rate of an epoxy embedded copper wire with a diameter of 0.64 mm was only about 180 μm/hr for first two hours. Stirring the etchant solution improved etching rate. One test showed that the etching rate for copper wires (d=0.64 mm) embedded in epoxy in C-38 at 36° C. when ultrasonically stirred (i.e. agitated) was 2.7 times as large as that when stirring with a magnetic stirring bar during a 24 hour period. Although stirring or agitating can improve etching rates, if too violent such as by excess ultrasonic agitation damage to microstructures can result. An example of what excess stirring can do to structures produced by electrochemical fabrication is shown in the scanning electron microscope (SEM) image of FIG. 7, in which ultrasonic stirring was used to help release the microstructure. It appears that the vibration ruptured the structure at edge 102 of the nickel deposit 104 on nickel substrate 106. As opposed to the vibrations themselves being too violent, another possible explanation is that the frequency of the vibrations excited resonance in the deposited structure which resulted in its failure.

The C-38 wet etching process is followed by a drying process to remove the liquid in the microstructure. Because of the surface tension of the rinse water, the released free-standing structures can tend to stick to the substrate. Once a structure is attached to the substrate by sticking, the mechanical force needed to dislodge it usually is large enough to damage the structure. In some MEMS processes, it has been proposed that this problem be overcome by use of freezing-sublimation or a CO2 supercritical drying process. However, these techniques can be process intensive, time consuming and often require sophisticated high-pressure apparatus. In electrochemical fabrication, a relatively simple method is preferred. After rinsing the part, it is immediately transferred into an alcohol solution where the alcohol is made to replaces the water in the structure. The structure is then immediately transferred to an oven at ˜60° C. for 5-10 minutes to evaporate the alcohol and dry the structure.

The preferred procedure for releasing structures (i.e. copper from nickel structures) produced by electrochemical fabrication involves surrounding the combined copper/nickel structure with a diluted C-38 etchant without any stirring. The preferred dilution is about one part C-38 by volume to about four to five parts H2O. In some embodiments though, the level of dilution may range from as low as about one part C-38 to about ten parts waters and as high as undiluted C-38. The etching endpoint is reached when a blue substance stops appearing from the structure and in particular from any cavity ports within the structure. The structure is then dipped into a DI water tank and is slowly moved through the water so as to displace the etchant with the water. The structure is then transferred to an alcohol tank where the structure is slowly moved through the alcohol to displace the water with alcohol and it is thereafter removed from the tank and dried in an oven.

Ni is considered to be a slightly noble metal. It resists corrosion in many environments due to its high passivation tendency. Usually there is a passive oxide or hydrated oxide film on the nickel surface which produces good corrosion resistance. In neutral and moderately alkaline solutions, a passive surface layer of Ni(OH)2 and perhaps NiO forms on nickel surface, while the passive film is possibly NiOOH in strongly oxidizing neutral and alkaline conditions such as in a C-38 environment (i.e. in an alkaline oxidizing solution).

Passive films protecting metals and alloys break down locally in certain corrosion environments and pitting results. Local points undergo anodic dissolution to form pits on the surface, while the major part of the surface remains passive. Usually, the diameter of pits is in the range of tens of micrometers and the depth of pits is equal to or more than their diameter. Obviously, formation of pits on nickel is unacceptable to microstructures. C-38 works well in etching copper without attacking nickel. However, occasionally pits have been observed to form on the nickel substrate and nickel deposits. FIG. 8 shows an SEM image of pits on a nickel deposit. A possible explanation for these phenomena is that chlorite is not very stable and could decompose by light, temperature and catalysts to produce hypochlorite and/or chloride ions, especially for aged or used C-38 solutions. In addition, as indicated in the above basic reaction equations hypochlorite is also produced during the etching process. Hypochlorite could attack nickel to form pits. Based on these possibilities, some preferred electrochemical fabrication etching processes involving C-38 include one or more of, and more preferably all of, (1) minimizing the C-38's contact with light, high temperature, or air during its storage period; (2) mixing the two components just before etching to ensure the freshness of the etchant; (3) checking the pH of the C-38 prior to each use to make sure it has a pH between 9.3 and 10.5.

Additional preferred electrochemical fabrication etching processes add a corrosion inhibitor to the C-38 to help prevent pitting. The use of a corrosion inhibitor in combination with the etchant may be done in alone or in addition to the above noted handling and checking preferences. The preferred inhibitor for use in etching electrochemical fabrication structures with a chlorite based etchant like C-38 is sodium nitrate, NaNO3.

Corrosion inhibitors are chemical compounds which, when added in small concentration to a corrosion environment, can greatly increase the corrosion resistance of an exposed metal. It is known that nitrate can be used as a pitting inhibitor for steels, stainless steels, aluminum and its alloys, and for nickel. For nickel, it is believed that the anti-pitting mechanism of NaNO3 is due to the preferential adsorption of NO3—on the nickel surface. In this way, NO3—ions prevent aggressive ions like ClO— from adsorbing on the surface to cause pitting. The presence of the nitrate can shift a pitting potential (Epit) to a more noble value. Its efficiency can be evaluated by a pitting scan which is a potentiodynamic polarization curve measurement in which Epit is determined from the anodic polarization curve as the potential where the current density sharply increases due to breakdown of the passive film and formation of pits. Pits initiate and grow above Epit, but not below. The more positive the Epit, the better the efficiency of the inhibitor.

A test was performed to determine if the present of NaNO3 could raise the Epit value. The test was performed using polished nickel disks having diameters of 1.27 cm. Pitting scans were conducted in 0.5 N NaCl with and without NaNO3 (1 g/100 ml) using an EG&G 273A Potentiostat/Galvanostat in accordance with ASTM G5 and G61. The scan rate was 0.166 mV/s. Polarization curves with and without NaNO3 are shown in FIG. 8. Epit increased by about 90 mV in the presence of 1 g NaNO3/100 mL of NaNO3. An additional test indicated that when only 0.1 g/100 ml NaNO3 was added, no shift of Epit occurred. It is believed that a concentration of NaNO3 sufficient to raise the Epit value by about 10 mV would yield some improvement in performance though having it be raised to about 30 mV or more preferably by about 50 mV would be better. In any event, an effective quantity of an antipitting agent may be empirically determined by those of skill in the art in view of the teachings herein such that pitting is eliminated or brought down to a tolerable level.

An experiment was performed to determine the effect of the presence of NaNO3 on the copper etching rate. The determined etching rate of copper foil in C-38 containing 1 g/100 ml NaNO3 was 430 μm/hr compared to 460 μm/hr without NaNO3 suggesting that the presence of NaNO3 has only a small effect on copper etching and that the effectiveness of the etchant remains. Experiments have also shown that pitting is reduced when etching with C-38 in combination with a small amount of NaNO3 (sodium nitrate). It is believed that the concentration of C-38 may be lowered to about 0.5 g/100 ml and still have obtain a benefit from the process and raised well above the 1 g/100 ml concentration level without bringing harm to the etching process though a point may be reached where little additional benefit is added by the increased concentration.

Wet chemical sacrificial etching is dependent on the reacting species reaching the etching surface (e.g. by diffusion). If the etching area is relatively large and open to the etchant, and the etching length of the sacrificial layer is short (e.g. <100 μm), the etchant can always be sufficiently supplied at the etching front. This etching mode is called reaction-limited etching. However, if the etching length is very long compared to the channel width such as in channel etching or where the etchant flow is severely restricted due to cavities or structures with irregularly shaped interfaces, the etchant may be depleted at the etching front. This is known as the diffusion-limited etching mode. In this mode, etching may become extremely slow or even stop. FIG. 9 depicts a plot of etched copper length versus time in a one-dimensional etching test that was carried out in C-38 at 38° C. aided by ultrasonic stirring for a 40 μm diameter copper wire (one end of an epoxy embedded copper wire is exposed to the etchant). With time, the etching rate dramatically decreased and after 5 hours, etching practically stopped.

To eliminate the limitation of diffusion of chemical species in wet chemical etching, it is believed that some form of electrochemical anodic etching may be used to assist in the removal of copper particularly from complex geometries such as narrow passages and blind cavities. Besides the chemical etching effect of an etchant itself on copper, electrochemical anodic etching provides also for anodic dissolution by passing current through the etchant to the surface to be etched. In addition, the applied electric field can drive copper ions through the etchant away from the structure being etched toward a cathode while simultaneously attracting anions to the surface of the structure, thus creating higher material transfer rate and helping to bring unreacted fluid closer to the copper front due to conservation of mass.

Preliminary electrochemical anodic etching of both the DC and biased AC type were investigated for use with electrochemical fabrication produced structures. C-38 was used as the etchant. Based on these preliminary investigations, electrochemical etching seems to be a promising copper etching technique.

The patent applications and patents set forth below are hereby incorporated by reference herein as if set forth in full. The teachings in these incorporated applications can be combined with the teachings of the instant application in many ways: For example, enhanced methods of producing structures may be derived from some combinations of teachings, enhanced structures may be obtainable, enhanced apparatus may be derived, and the like.

| US Pat App No, Filing Date | |
|---|---|
| US App Pub No, Pub Date | Inventor, Title |
| 09/493,496 - Jan. 28, 2000 | Cohen, “Method For Electrochemical Fabrication” |
| 10/677,556 - Oct. 1, 2003 | Cohen, “Monolithic Structures Including Alignment |
| | and/or Retention Fixtures for Accepting Components” |
| 10/830,262 - Apr. 21, 2004 | Cohen, “Methods of Reducing Interlayer |
| | Discontinuities in Electrochemically Fabricated Three- |
| | Dimensional Structures” |
| XX/XXX,XXX - May 7, 2004 | Lockard, “Methods for Electrochemically Fabricating |
| (Docket P-US099-A-MF) | Structures Using Adhered Masks, Incorporating |
| | Dielectric Sheets, and/or Seed layers That Are |
| | Partially Removed Via Planarization” |
| 10/271,574 - Oct. 15, 2002 | Cohen, “Methods of and Apparatus for Making High |
| 2003-0127336A - Jul. 10, 2003 | Aspect Ratio Microelectromechanical Structures” |
| 10/697,597 - Dec. 20, 2002 | Lockard, “EFAB Methods and Apparatus Including |
| | Spray Metal or Powder Coating Processes” |
| 10/677,498 - Oct. 1, 2003 | Cohen, “Multi-cell Masks and Methods and Apparatus |
| | for Using Such Masks To Form Three-Dimensional |
| | Structures” |
| 10/724,513 - Nov. 26, 2003 | Cohen, “Non-Conformable Masks and Methods and |
| | Apparatus for Forming Three-Dimensional Structures” |
| 10/607,931 - Jun. 27, 2003 | Brown, “Miniature RF and Microwave Components |
| | and Methods for Fabricating Such Components” |
| XX/XXX,XXX - May 7, 2004 | Cohen, “Electrochemical Fabrication Methods |
| (Docket P-US093-A-MF) | Including Use of Surface Treatments to Reduce |
| | Overplating and/or Planarization During Formation of |
| | Multi-layer Three-Dimensional Structures” |
| 10/387,958 - Mar. 13, 2003 | Cohen, “Electrochemical Fabrication Method and |
| 2003-022168A - Dec. 4, 2003 | Application for Producing Three-Dimensional |
| | Structures Having Improved Surface Finish” |
| 10/434,494 - May 7, 2003 | Zhang, “Methods and Apparatus for Monitoring |
| 2004-0000489A - Jan. 1, 2004 | Deposition Quality During Conformable Contact Mask |
| | Plating Operations” |
| 10/434,289 - May 7, 2003 | Zhang, “Conformable Contact Masking Methods and |
| 20040065555A - Apr. 8, 2004 | Apparatus Utilizing In Situ Cathodic Activation of a |
| | Substrate” |
| 10/434,294 - May 7, 2003 | Zhang, “Electrochemical Fabrication Methods With |
| 2004-0065550A - Apr. 8, 2004 | Enhanced Post Deposition Processing Enhanced |
| | Post Deposition Processing” |
| 10/434,295 - May 7, 2003 | Cohen, “Method of and Apparatus for Forming Three- |
| 2004-0004001A - Jan. 8, 2004 | Dimensional Structures Integral With Semiconductor |
| | Based Circuitry” |
| 10/434,315 - May 7, 2003 | Bang, “Methods of and Apparatus for Molding |
| 2003-0234179 A - Dec. 25, | Structures Using Sacrificial Metal Patterns” |
| 2003 | |
| 10/434,103 - May 7, 2004 | Cohen, “Electrochemically Fabricated Hermetically |
| 2004-0020782A - Feb. 5, 2004 | Sealed Microstructures and Methods of and |
| | Apparatus for Producing Such Structures” |
| XX/XXX,XXX - May 7, 2004 | Thompson, “Electrochemically Fabricated Structures |
| (Docket P-US104-A-MF) | Having Dielectric or Active Bases and Methods of and |
| | Apparatus for Producing Such Structures” |
| 10/434,519 - May 7, 2003 | Smalley, “Methods of and Apparatus for |
| 2004-0007470A - Jan. 15, 2004 | Electrochemically Fabricating Structures Via |
| | Interlaced Layers or Via Selective Etching and Filling |
| | of Voids” |
| 10/724,515 - Nov. 26, 2003 | Cohen, “Method for Electrochemically Forming |
| | Structures Including Non-Parallel Mating of Contact |
| | Masks and Substrates” |
| XX/XXX,XXX - May 7, 2004 | Cohen, “Multi-step Release Method for |
| (Docket P-US105-A-MF) | Electrochemically Fabricated Structures” |

Various other embodiments of the present invention exist. Some of these embodiments may be based on a combination of the teachings herein with various teachings incorporated herein by reference. Some embodiments may not use any blanket deposition process and/or they may not use a planarization process. Some embodiments may involve the selective deposition of a plurality of different materials on a single layer or on different layers. Some embodiments may use blanket depositions processes that are not electrodeposition processes. Some embodiments may use selective deposition processes on some layers that are not Instant Mask processes and are not even electrodeposition processes.

Some embodiments may use nickel as a structural material. Some embodiments may use nickel alloys as a structural material, such as nickel-phosphorous (NiP), nickel-cobalt (NiC), nickel-iron (NiFe), nickel-manganese (NiMn), and the like. Some embodiments may use a different material or alloy as a structural material, e.g. gold, tin or solder, or any other material or materials that can be separated from a sacrificial material (e.g. copper, zinc, silver, alloys of these mateials, or the like). The structural material and/or the sacrificial material may be electrodepositable, electroplatable, or depositable in some other manner. In some embodiments, the nitrate salt used as a corrosion or pitting inhibitor may be different from sodium nitrate, e.g. it may be ammonium nitrate or potassium nitrate 6.

In some embodiments instead of using a nitrate salt as discussed above it may be possible to use other corrosion inhibitors such as for example:
1. Sulfate salts such as potassium sulfate, sodium sulfate and ammonium sulfate;
2. Phosphate salts such as potassium phosphate, sodium phosphate and ammonium phosphate (e.g. phosphate, monobasic and phosphate, dibasic);
3. Carbonate salts such as potassium carbonate, sodium carbonate and ammonium carbonate (in some altenatives, carbonate may be replaced by bicarbonate);
4. Molybdate salts such as potassium molybdate, sodium molybdate and ammonium molybdate; and
5. Silicate salts such as potassium silicate, sodium silicate and ammonium silicate.

In some embodiments the various corrosion inhibitors mentioned herein may be used in combination.

In some embodiments the anode may be different from a CC mask support and the support may be a porous structure or other perforated structure. Some embodiments will use multiple masks (e.g. CC masks or adhered masks with different patterns so as to deposit different selective patterns of material on different layers and/or on different portions of a single layer. In some embodiments, the depth of deposition is occurring in a manner that allows the seal between the conformable portion of the CC mask and the substrate to shift from the face of the conformal material to the inside edges of the conformable material.

In view of the teachings herein, many further embodiments, alternatives in design and uses of the instant invention will be apparent to those of skill in the art. As such, it is not intended that the invention be limited to the particular illustrative embodiments, alternatives, and uses described above but instead that it be solely limited by the claims presented hereafter.

1. An electrochemical fabrication process for producing a three-dimensional structure from a pluralilty of adhered layers, the process comprising:
(A) selectively depositing a first material onto a substrate to form a portion of a layer and depositing at least a second material to form another portion of the layer, wherein the substrate may comprise previously deposited material, and wherein one of the first material or the second material is a structural material and the other is a sacrificial material;
(B) forming a plurality of layers such that each successive layer is formed adjacent to and adhered to a previously deposited layer, wherein said forming comprises repeating operation (A) a plurality times, wherein during formation of at least one layer an adhered mask is used in selectively depositing the first material; and
(C) after formation of a plurality of layers, separating at least a portion of the sacrificial material from the structural material using an etching solution that comprises ammonium hydroxide, a chlorite salt, and a nitrate salt.

2. The process of claim 1 additionally comprising:
(D) supplying a plurality of preformed masks, wherein each mask comprises a patterned dielectric material that includes at least one opening through which deposition can take place during the formation of at least a portion of a layer, and wherein each mask comprises a support structure that supports the patterned dielectric material; and
wherein at least a plurality of the selective depositing operations comprise:
(1) contacting the substrate and the dielectric material of a selected preformed mask or proximately locating the substrate and dielectric material of the selected preformed mask;
(2) in presence of a plating solution, conducting an electric current through the at least one opening in the selected mask between an anode and the substrate, wherein the anode comprises a selected deposition material, and wherein the substrate functions as a cathode, such that the selected deposition material is deposited onto the substrate to form at least a portion of a layer; and
(3) separating the selected preformed mask from the substrate.

3. The process of claim 1 wherein a plurality of selective depositing operations comprise:
(1) adhering a mask having a desired pattern to the substrate, wherein the mask includes at least one opening;
(2) in presence of a plating solution, conducting an electric current through the at least one opening in the adhered mask between an anode and the substrate, wherein the anode comprises a selected deposition material, and wherein the substrate functions as a cathode, such that the selected deposition material is deposited onto the substrate to form at least a portion of a layer; and
(3) separating the mask from the substrate.

4. The process of claim 2 wherein the plating solution is at a temperature below about 43° C. when conduction of the electric current begins.

5. The process of claim 2 wherein the plating solution is at a temperature below about 38° C. when conduction of the electric current begins.

6. The process of claim 2 wherein the plating solution is not agitated during selective deposition.

7. The process of claim 1 wherein the formation of each of a number of layers comprise at least one blanket deposition as well as the selective deposition wherein for a given layer the selectively deposited material is different from a material deposited by blanket deposition.

8. The process of claim 1 wherein the plurality of selective depositions comprise the deposition of a plurality of different materials.

9. The process of claim 1 wherein at least a portion of one layer is formed by a non-electroplating deposition process.

10. The process of claim 1 wherein a plurality of depositions occur during the formation of each of a number of layers wherein at least one of the depositions on each of the number of layers deposits copper and at least one of the other depositions on the number of layers deposits nickel.

11. The process of claim 1 wherein the selective depositing for each of a number of layers comprises at least two selective depositions.

12. The process of claim 1 wherein a number of the plurality of layers are each formed by depositing at least one structural material using at least one deposition and by depositing at least one sacrificial material by using at least one other deposition.

13. The process of claim 12 wherein at least a portion of the at least one sacrificial material is removed after formation of a plurality of layers to reveal a three-dimensional structure comprised of at least one structural material.

14. The process of claim 2 wherein, for each of a plurality of masks, the support for the dielectric material for a mask comprises the anode involved in the deposition associated with the use of the mask.

15. The process of claim 2 wherein, for each of a plurality of masks, the support for the dielectric material for a mask is a porous medium which does not act as the anode during involved in the deposition associated with the use of the mask.

16. The process of claim 1 wherein the formation of at least a plurality of layers additionally comprises removing a portion of the deposited material from the substrate such that a desired surface level is obtained.

17. The process of claim 1 wherein the at least one sacrificial material comprises copper.

18. The process of claim 1 wherein the at least one structural material comprises nickel.

19. The process of claim 1 wherein the chlorite salt in the etching solution comprises sodium chlorite.

20. The process of claim 1 wherein the nitrate salt comprises sodium nitrate

21. The process of claim 1 wherein during etching, the structure and etchant are moved relative to one another.

22. The process of claim 1 wherein the etching process is aided by application of an electric potential between the substrate and an electrode immersed in the etching solution.

23. An electrochemical fabrication process for producing a three-dimensional structure from a plurality of adhered layers, the process comprising:
(A) selectively patterning a first material on a substrate to form a portion of a layer and depositing at least a second material to form another portion of the layer, wherein the substrate may comprise previously deposited material, and wherein one of the first material or the second material is a structural material and the other is a sacrificial material;
(B) forming a plurality of layers such that each successive layer is formed adjacent to and adhered to a previously deposited layer, wherein said forming comprises repeating operation (A) a plurality times, wherein during formation of at least one layer an adhered mask is used in selectively patterning the first material; and
(C) after formation of a plurality of layers, separating at least a portion of the sacrificial material from the structural material using an etching solution that comprises ammonium hydroxide, a chlorite salt, and a nitrate salt.

24. The process of claim 23 wherein the at least one sacrificial material comprises copper and the at least one structural material comprises nickel.

25. The process of claim 23 wherein the chlorite salt in the etching solution comprises sodium chlorite.

26. The process of claim 23 wherein the nitrate salt comprises sodium nitrate

27. The process of claim 23 wherein during etching, the structure and etchant are moved relative to one another.

28. The process of claim 23 wherein the etching process is aided by application of an electric potential between the substrate and an electrode immersed in the etching solution.

29. An electrochemical fabrication process for producing a three-dimensional structure from a plurality of adhered layers, the process comprising:
(A) selectively depositing a first material onto a substrate to form a portion of a layer and depositing at least a second material to form another portion of the layer, wherein the substrate may comprise previously deposited material, and wherein one of the first material or the second material is a structural material and the other is a sacrificial material;
(B) forming a plurality of layers such that each successive layer is formed adjacent to and adhered to a previously deposited layer, wherein said forming comprises repeating operation (A) a plurality times, wherein during formation of at least one layer an adhered mask is used in selectively depositing the first material; and
(C) after formation of a plurality of layers, separating at least a portion of the sacrificial material from the structural material using an etching solution that comprises a corrosion inhibitor.
